(19) United States
(12) Patent Application Publication
(10) Pub. No.: US 2010/0226741 A1
(43) Pub. Date: Sep. 9, 2010

(54) WEIGHT SLED PAYLOAD SIMULATOR

(75) Inventors: Brandon Mancini, Endwell, NY (US); Frank H. Mrakovcic, Owego, NY (US); Navin Patel, Vestal, NY (US); Albert E. Smith, JR., Spencer, NY (US); Ryan Taylor, Friendsville, PA (US); Mark A. Walker, Vestal, NY (US); Joseph P. Zanovitch, Barton, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/397,037

(22) Filed: Mar. 3, 2009

(51) Int. Cl. B60P 3/00

(52) U.S. Cl. 414/462; 414/800

(57) ABSTRACT

A load bearing apparatus is configured to simulate a payload. The load bearing apparatus includes a load member configured to simulate the mass of a payload, a frame having frame members, a plurality of retainers configured to support the load member, and first and second outer guides coupled to the load member. The plurality of retainers includes a first retainer positioned at a first height and configured to support the load member at the first height, and a second retainer positioned at a second height different from the first height and configured to support the load member at the second height. The first and second outer guides are coupled to the load member and are configured to receive therebetween at least one lifting member of a lifting device. By using load members of different weights and positioning them at varying heights, different centers of gravity can be achieved.

### BACKGROUND

The present invention relates to payload simulation for vehicle testing.

Payload simulators, or weight simulators, are loaded onto a vehicle or a trailer to add weight and alter the center of gravity of the vehicle to simulate a payload during vehicle testing. Weight simulators include plastic water dummies filled with water to a desired weight, sand boxes filled with sand to a desired weight, concrete blocks, and weighted pallets. These weight simulations lack repeatability and differ from test center to test center.

### SUMMARY

In one aspect, the invention provides a load bearing apparatus configured to simulate a payload. The load bearing apparatus includes a load member configured to simulate the mass of a payload, a frame having frame members, and a plurality of retainers supported by the frame and configured to support the load member. The plurality of retainers includes a first retainer positioned at a first height and configured to support the load member at the first height, and a second retainer positioned at a second height different from the first height and configured to support the load member at the second height.

In another aspect, the invention provides a load bearing apparatus configured to simulate a payload. The load bearing apparatus includes a load member and a frame. The load member is configured to simulate the mass of a payload, and the load member has a predetermined mass. The frame has frame members defining a space configured to at least partially include the load member. The load bearing apparatus also includes means for supporting the load member at a first height and at a second height different from the first height, wherein the load member is configured to be positioned at the first height and configured to be positioned at the second height.

In yet another aspect, the invention provides a method of simulating a payload. The method includes providing a frame structure having frame members that have a plurality of retainers at a plurality of heights, providing a load member, positioning the load member within the frame structure, and retaining the load member at a first height by coupling the load member to a frame member using at least one of the plurality of retainers.

Other aspects of the invention will become apparent by consideration of the detailed description and accompanying drawings.

### BRIEF DESCRIPTION OF THE DRAWINGS

FIG. 1 is a side view of a vehicle and trailer including weight sleds according to one embodiment of the invention.

FIG. 2A is a front perspective view of one of the weight sleds of FIG. 1 having weight slabs.

FIG. 2B is a left side view of the weight sled of FIG. 2A.

FIG. 3A is a perspective view of one of the weight slabs of FIGS. 2A-2B.

FIG. 3B is a perspective view of another one of the weight slabs of FIGS. 2A-2B.

FIG. 3C is a perspective view of a weight slab.

FIG. 3D is a perspective view of yet another one of the weight slabs of FIGS. 2A-2B.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

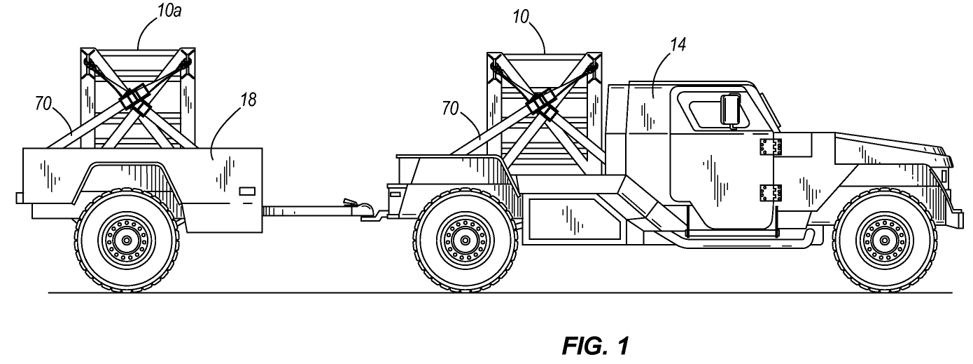

FIG. 1 illustrates a weight sled 10 secured to the bed of a vehicle 14, and a second weight sled 10a secured to a trailer 18 for simulating a vehicle payload and a trailer payload. It is to be understood that the first and second weight sleds 10, 10a are substantially similar or the same, although they may be arranged to have different weights and centers of gravity, as will be described in greater detail below. The description of the first weight sled 10, below, can be used to describe the second weight sled 10a. The weight sled 10 is secured to a vehicle or trailer, such as a military vehicle or trailer, to simulate the weight and center of gravity of a payload. The weight sled could also be used with other vehicles such as trains, boats, ships or commercial trucks. It is not necessary that both weight sleds 10 and 10a be used at the same time.

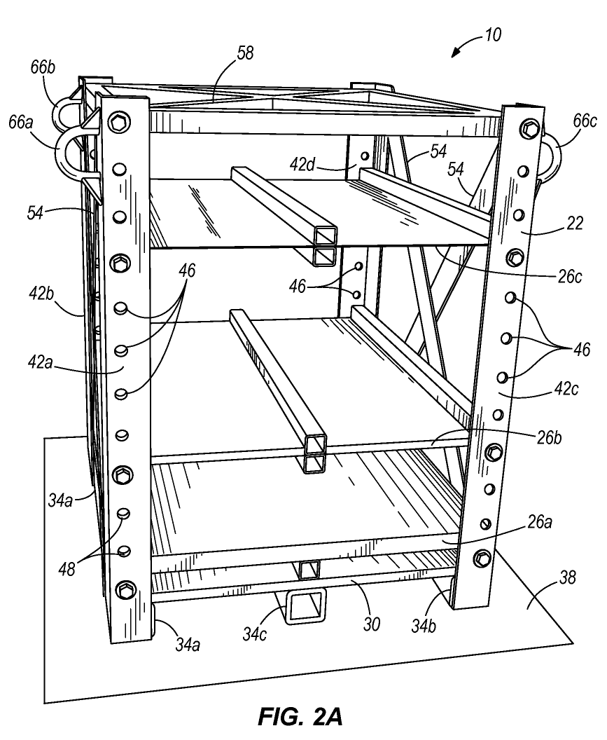

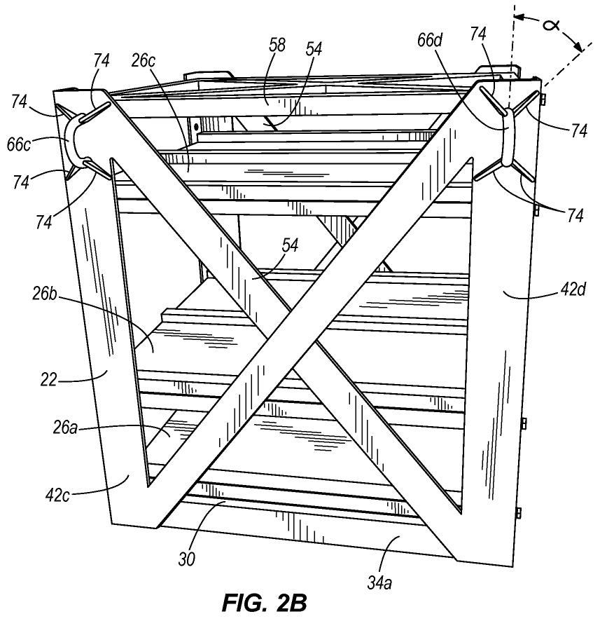

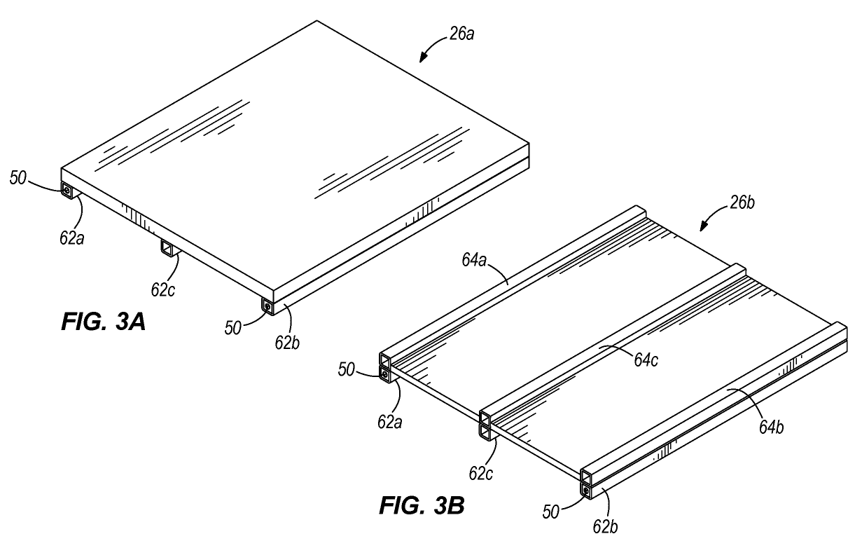

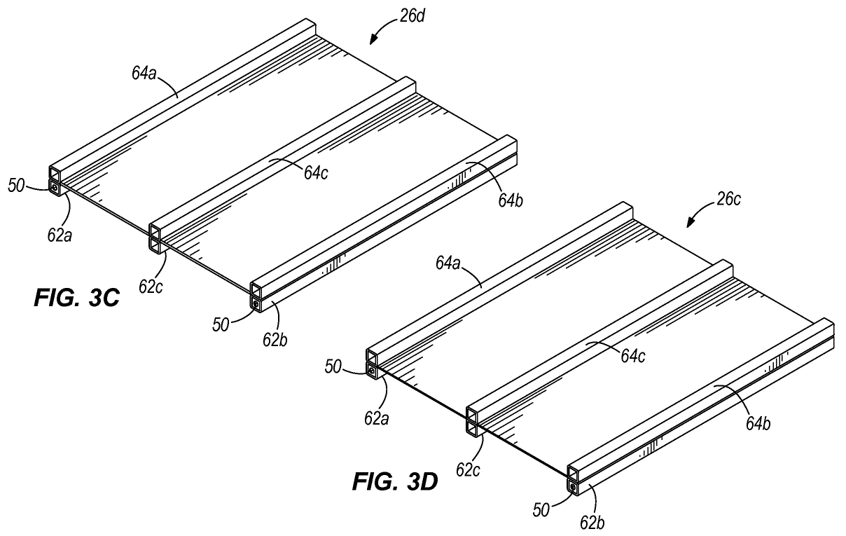

With reference to the embodiment shown in FIGS. 2A-3D, the weight sled 10 has a frame 22 and weight slabs 26a-26d, or load members, of the same or varying weights. In the illustrated construction, weight slabs of varying weights are shown. As best shown in FIGS. 1, 2A and 2B, weights 26a, 26b and 26c may be spaced at varying heights to achieve different centers of gravity. For the purpose of description, the frame 22 has a front, a rear, a left side, a right side, a top and a bottom. A base 30 is positioned at the bottom and is preferably structured like a pallet to accommodate a forklift or other lifting device to allow for easy loading and unloading onto a vehicle or trailer. Three guides 34a-34c, or spacers, of tubular steel or another suitable material are welded, or otherwise fastened, to the bottom of the base 30 to provide a space between the bottom of the base 30 and a support surface 38. The three guides 34a-34c include two outer guides 34a, 34b coupled to the base of the frame and preferably one intermediate guide 34c positioned between the pair of outer guides 34a, 34b and coupled to the base 30 of the frame 22. The pair of outer guides 34a, 34b and the intermediate guide 34c are substantially parallel. The guides 34a-34c are dimensioned to provide adequate space to accommodate the tines of a forklift or other lifting vehicle or device. In the illustrated construction, the base 30 is substantially rectangular and has dimensions of approximately forty inches by forty-eight inches, after the weight sled 10 is welded. The base 30 is preferably made of steel; however, in other constructions, other suitable materials may be employed. In other constructions, a structure other than guides 34a, 34b may be used to assist a lifting device in lifting the load member. In the illustrated construction, the weight slabs 26a-26d are constructed substantially symmetrically and are balanced in weight from front-to-rear and side-to-side. In other constructions, the weight slabs 26a-26d can be asymmetrically constructed and unbalanced to allow the front-to-rear or side-to-side balance of the weight sled 10 to be varied.

Four vertical frame members or uprights 42a-42d are coupled to the base 30, one upright at each corner of the base 30. A first upright 42a is positioned at the front left corner of the base 30, a second upright 42b is positioned at the rear left corner of the base 30, a third upright 42c is positioned at the front right corner of the base 30, and a fourth upright 42d is positioned at the rear right corner of the base 30. The uprights 42a-42d are preferably welded to the base 30, although other fastening means are also possible. The weight sled 10 has an overall height of approximately sixty-two inches, after welding. The uprights 42a-42d are preferably made of angle iron; however, other suitable materials may be employed in other constructions.

The uprights 42a-42d include retainers for supporting the weight slabs 26a-26d at a plurality of different heights, as illustrated in FIGS. 2A-2B. In the illustrated construction, ten apertures 46 are spaced evenly and vertically on each upright 42a-42d. The weight slabs 26a-26d include complimentary retaining features 50, such as end caps in the outer guides 34a-34b containing complimentary apertures (illustrated in FIGS. 3A-3D) or apertures elsewhere in the outer guides 34a-34b through which fasteners 48, such as bolts or pins, can be used to couple the weight slabs 26a-26d to the uprights 42a-42d of the frame 22. In other constructions, the retainers may include fixed or removable support brackets, or the like, coupled to the uprights 42a-42d and providing a support surface on which the weight slabs 26a-26d can rest. In further constructions, other retainers may be employed to retain the weight slabs 26a-26d at a plurality of different heights.

Side cross members 54 are positioned between adjacent uprights 42a-42d on at least two sides of the frame 22 to provide structural support, rigidity and strength to the frame 22. In the illustrated construction, the side cross members 54 are formed of strips of steel plate welded in an X-shape from the top of one upright 42a-42d to the bottom of an adjacent upright 42a-42d. The side cross members 54 are preferably located on the sides having hooks for tie-downs, which will be described in greater detail below, to compressively absorb the angled loads induced by the tie-downs. In other constructions, the side cross members 54 may be formed of other suitable materials.

A removable top cross member 58 is bolted to the top of the frame 22 to provide structural support, rigidity and strength to prevent the uprights 42a-42d from flexing. In the illustrated construction, the top cross member 58 is formed of square tubular steel. The top cross member 58 includes a welded rectangular frame having tubular steel welded in an X-shape between corners of the rectangular frame. The top cross member 58 is bolted to the uprights 42a-42d such that the top cross member 58 can be removed to allow the weight slabs 26a-26d to be lowered in and lifted out of the frame 22 by the forklift or other lifting device. In the illustrated construction, the top cross member 58 is welded together to form a single piece for bolting to the uprights 42a-42d; however, in other constructions, the top cross member 58 may include multiple discrete parts bolted to the uprights 42a-42d and may be formed of other suitable materials.

Together, the base 30, the uprights 42a-42d, the top cross member 58 and the side cross members 54 define a space in which the weight slabs 26a-26d are retained. Each weight slab 26a-26d, or load member, is substantially planar and can be retained in the frame 22 at multiple heights to simulate various centers of gravity, depending on the height chosen. Each weight slab 26a-26d may have a different weight to further allow for control and variation of the center of gravity—including varying the height of each load member—and overall weight of the weight sled. Multiple weight slabs 26a-26d having the same weight may also be employed. For example, in the illustrated construction of FIGS. 2A-2B, three different weight slabs 26a, 26b, 26c having three different weights are employed. Each weight slab 26a-26d may be positioned at any of the heights allowed by the retainers 46 to achieve different centers of gravity. The weight slabs 26a-26d need not be positioned immediately adjacent each other. In other words, the weight slabs 26a-26d can be retained in the frame 22 while leaving unused retainers 46 in between the weight slabs 26a-26d. In the illustrated construction, the first weight slab 26a is substantially one-thousand pounds (FIG. 3A), the second weight slab 26b is substantially five-hundred pounds (FIG. 3B), and the third weight slab 26c is substantially one-hundred pounds (FIG. 3D). A fourth weight slab 26d weighing substantially two-hundred pounds may also be employed (FIG. 3C). In other constructions, weight slabs having other weight values may be employed. In the illustrated construction, the frame 22 is constructed to accommodate up to nine weight slabs 26a-26d in any combination of weights and heights, and is designed to accommodate this weight at a 5-4-2 G-loading (the equivalent of five gravitational-forces (5 g) vertically, four gravitational-forces longitudinally, and two gravitational-forces laterally). Therefore, the maximum weight of the sled 10 would be nine-thousand pounds plus the weight of the frame 22 itself, equaling approximately ten-thousand pounds in total. To allow for a safety factor, the total weight preferably does not exceed six-thousand pounds. In other constructions, the frame 22 may be constructed to accommodate a different number of weight slabs 26a-26d having the same or different weight values, depending on the desired load or center of gravity to be simulated. The weight slabs 26a-26d may also be formed in other shapes and configurations that allow various centers of gravity and overall weights to be simulated. An optional steel box, not shown, may be retained in the frame 22 by way of the retainers 46. The steel box may contain quantities of sand and/or gravel adjusted for fine-tuning the weight of the sled 10. Tie-down attachment points and forklift guides, similar to those described below, may be welded or otherwise attached to the steel box.

Each weight slab 26a-26d includes a pair of outer guides 62a, 62b coupled to the weight slab 26a-26d and preferably an intermediate guide 62c positioned between the pair of outer guides 62a, 62b and coupled to the weight slab 26a-26d, such that the weight slab 26a-26d is transportable by a forklift. The pair of outer guides 62a, 62b and the intermediate guide 62c are substantially parallel. The first weight slab 26a includes only one set of three guides 62a-62c because the thickness of the weight slab 26a itself substantially equals the thickness of one guide. Weight slabs having a thickness lesser than that of the guides 62a-62c, such as the second, third and fourth weight slabs 26b-26d, may include a second set of the three guides 64a-64c, as illustrated. This ensures that each weight slab 26a-26d has an overall thickness equal to approximately two guide-thicknesses for ease of storage and transportation. In the illustrate construction, the overall thickness of the weight slabs 26a-26d including the guides 62a-62c, 64a-64c is approximately four inches.

Tie-down attachment points, such as first and second hooks 66a, 66b, respectively, or handles are welded, or otherwise fastened, to the left side of the first and second uprights 42a, 42b, respectively; and third and fourth hooks 66c, 66d, respectively, or handles are welded, or otherwise fastened, to the right side of the third and fourth uprights 42c, 42d, respectively, such that the first and second handles 66a, 66b are opposite the third and fourth handles 66c, 66d. The handles 66a-66d are structured to provide attachment points for tie-downs 70 (shown in FIG. 1) to secure the frame 22 to the vehicle or trailer to be tested. The vehicle or trailer may already be adapted for receiving the tie-downs, or a frame for the vehicle or trailer may be constructed to be integrated with the vehicle or trailer and to provide the needed tie-down receiving structure for securing the weight sled 10 to the vehicle or trailer. It can be made possible to adjust the location of the weight sled 10 between the front and the rear and left and right of the vehicle or trailer in order to adjust the weight balance from the front to the rear or side to side. The tie-down attachment points, or handles 66a-66d, could be placed in different locations, including the front or back of the frame, or even the top of the frame if a wider frame is desired. In the illustrated construction, the handles 66a-66d are made of semi-circular curved steel bar stock; however, in other constructions the handles 66a-66d may be made of other suitable materials and may have other suitable shapes for providing attachment points for tie-downs. For example, the handles 66a-66d may be curved, triangular, rectangular, or could be hooks. Furthermore, the handles 66a-66d may alternatively or additionally be disposed on the front and rear sides of the sled 10.

Four gussets 74 are welded, or otherwise fastened, to each upright 42a-42d at an angle α of approximately 45 degrees relative to each upright 42a-42d. A first pair of gussets 74 abuts a first end of each handle 66a-66d and a second pair of gussets 74 abuts a second end of each handle 66a-66d. The gussets 74 are positioned to strengthen the weld joints where the handles 66a-66d are welded to the uprights 42a-42d.

Thus, the invention provides, among other things, a weight sled 10 for simulating the weight and center of gravity of a payload. The weight sled is safe, easy to use, and allows for repeatability of testing. Various features and advantages of the invention are set forth in the following claims.

What is claimed is:

1. A load bearing apparatus configured to simulate a payload, the load bearing apparatus comprising:
a load member configured to simulate the mass of a payload;
a frame having frame members; and
a plurality of retainers supported by the frame and configured to support the load member, the plurality of retainers including a first retainer positioned at a first height and configured to support the load member at the first height, and a second retainer positioned at a second height different from the first height and configured to support the load member at the second height.

2. The load bearing apparatus of claim 1, further comprising:
first and second outer guides coupled to the load member, the first and second outer guides being configured to receive therebetween at least one lifting member of a lifting device.

3. The load bearing apparatus of claim 2, further comprising an intermediate guide positioned between the first and second outer guides and coupled to the load member, the intermediate guide configured to receive the at least one lifting member of a lifting device between the intermediate guide and one of the first and second outer guides.

4. The load bearing apparatus of claim 2, further comprising:
a second load member configured to simulate the mass of a payload; and
third and fourth outer guides coupled to the second load member, the third and fourth outer guides being configured to receive therebetween at least one lifting member of a lifting device.

5. The load bearing apparatus of claim 4, further comprising a second intermediate guide positioned between the third and fourth outer guides and coupled to the second load member, the second intermediate guide configured to receive the at least one lifting member of a lifting device between the second intermediate guide and one of the third and fourth outer guides.

6. The load bearing apparatus of claim 4, wherein the third and fourth outer guides are substantially parallel.

7. The load bearing apparatus of claim 2, wherein the first and second outer guides are substantially parallel.

8. The load bearing apparatus of claim 2, wherein the frame includes third and fourth outer guides coupled to the frame, the third and fourth outer guides being configured to receive therebetween at least one lifting member of a lifting device.

9. The load bearing apparatus of claim 8, further comprising a second intermediate guide positioned between the third and fourth outer guides and coupled to the frame, the second intermediate guide configured to receive the at least one lifting member of a lifting device between the second intermediate guide and one of the third and fourth outer guides.

10. The load bearing apparatus of claim 2, wherein each of the outer guides has a respective guide aperture.

11. The load bearing apparatus of claim 2, wherein a first of the plurality of retainers comprises:
an aperture in one of the plurality of frame members; and
a fastener configured to extend through the aperture into one of the guide apertures.

12. The load bearing apparatus of claim 11, wherein a second of the plurality of retainers comprises:
a second aperture in one of the plurality of frame members; and
a second fastener configured to extend through the second aperture into another one of the guide apertures.

13. The load bearing apparatus of claim 1, further comprising:
a second load member configured to simulate the mass of a payload.

14. The load bearing apparatus of claim 13, wherein the first load member and the second load member are configured to be repositioned from one of the plurality of retainers to another of the plurality of retainers.

15. The load bearing apparatus of claim 1, wherein the first load member is substantially planar.

16. The load bearing apparatus of claim 1, further comprising a handle coupled to at least one of the frame members configured to accommodate a tie-down to secure the load bearing apparatus.

17. The load bearing apparatus of claim 1, wherein the frame members include a plurality of spaced vertical members, and wherein the plurality of retainers are coupled to the plurality of spaced vertical members.

18. The load bearing apparatus of claim 1, further comprising a second load member configured to simulate the mass of a payload, wherein the first load member has a first mass and the second load member has a second mass different from the first mass, and wherein the first retainer is configured to support the first load member at the first height, and wherein the second retainer is configured to support the second load member at the second height.

19. The load bearing apparatus of claim 1, further comprising a trailer, wherein the frame is configured to be attached to the trailer.

20. A load bearing apparatus configured to simulate a payload, the load bearing apparatus comprising:
a load member configured to simulate the mass of a payload, wherein the load member has a predetermined mass;
a frame having frame members defining a space configured to at least partially include the load member; and
means for supporting the load member at a first height and at a second height different from the first height, wherein the load member is configured to be positioned at the first height and configured to be positioned at the second height.

21. The load bearing apparatus of claim 20, further comprising:
means for guiding at least one lifting member of a lifting device such that at least one of the load member and the frame is configured to be lifted by the lifting device.

22. The load bearing apparatus of claim 21, wherein the frame includes a means for guiding the at least one lifting member of a lifting device such that the load bearing apparatus is transportable by the lifting device, wherein the means for guiding the at least one lifting member of a lifting device is one of the same as and different than the first means for guiding the at least one lifting member of a lifting device.

23. The load bearing apparatus of claim 20, further comprising:
a second load member configured to simulate the mass of a payload, wherein the second load member has a second predetermined mass.

24. The load bearing apparatus of claim 23, wherein the second predetermined mass is different from the first predetermined mass.

25. The load bearing apparatus of claim 23, wherein the first load member and the second load member are interchangeable between the first height and the second height.

28. The load bearing apparatus of claim 23, wherein the second load member includes a second means for guiding at least one lifting member of a lifting device.

27. The load bearing apparatus of claim 20, further comprising means for accommodating a tie-down to secure the load bearing apparatus.

28. The load bearing apparatus of claim 20, further comprising a trailer, wherein the frame is configured to be attached to the trailer.

29. A method of simulating a payload, the method comprising:
providing a frame structure having frame members, the frame members having a plurality of retainers at a plurality of heights;
providing a load member;
positioning the load member within the frame structure; and
retaining the load member at a first height by coupling the load member to a frame member using at least one of the plurality of retainers.

30. The method of claim 29, further comprising:
providing a second load member;
positioning the second load member within the frame structure; and
retaining the second load member at a second height different than the first height of the first load member using at least another one of the plurality of retainers.

31. The method of claim 29, wherein the act of providing the second load member includes providing a second load member having a mass different than the mass of the first load member.

32. The method of claim 29, further comprising configuring the frame structure to accommodate a tie-down to secure the frame structure to an apparatus.

33. The method of claim 29, wherein the providing a frame structure act includes providing a frame structure having a guide to guide a lifting device such that the frame structure can be transported using a lifting device.

34. The method of claim 29, wherein the retaining the load member act further includes utilizing at least one fastener to couple the load member to the frame member, wherein the at least one of the plurality of retainers is an aperture configured to receive the at least one fastener.

35. The method of claim 29, wherein the providing a load member act further comprises providing a load member having guides to guide at least one lifting member of a lifting device such that the load member can be positioned within the frame structure using a lifting device.

36. The method of claim 35, further comprising:
providing a second load member having second guides to guide a lifting device such that the second load member can be positioned within the frame structure using a lifting device.
